(19) United States
(12) Patent Application Publication
(10) Pub. No.: US 2025/0122130 A1
(43) Pub. Date: Apr. 17, 2025

(54) IMPROVEMENTS IN AND RELATING TO FERTILIZER COATING COMPOSITIONS

(71) Applicant: GLAZE COATINGS LIMITED, Hamilton (NZ)

(72) Inventors: Murray Selwin Zander, Hamilton (NZ); Jordan Ross Zander, Hamilton (NZ); Regan James Zander, Hamilton (NZ)

(21) Appl. No.: 18/684,646

(22) PCT Filed: Aug. 19, 2022
(86) PCT No.: PCT/NZ2022/050107

§ 371 Date: Feb. 16, 2024

(30) Foreign Application Priority Data
Aug. 20, 2021 (AU) 2021218200

(51) Int. Cl. C05G 3/90; C05C 9/00; C05G 5/12; C05G 5/30

(52) U.S. Cl. CPC C05G 3/90; C05C 9/00; C05G 5/12; C05G 5/30

(57) ABSTRACT

An aqueous urease inhibitor and/or nitrification inhibitor coating formulation consisting of: a thickening agent; NBPT or other urease inhibitors/nitrification inhibitors; and water.

### TECHNICAL FIELD

The present invention relates to improvements in and relating to fertiliser coating compositions. In particular, the present invention relates to improvements in and relating to, fertiliser coating compositions comprising urease inhibitors and/or nitrification inhibitors and/or fertiliser coating compositions including trace elements.

### BACKGROUND ART

Large scale farming of animals for fibre, leather, meat and dairy production and use of nitrogen-based fertilisers in agriculture will significantly increase as the human population grows from 7.7 billion to 9.8 billion by 20501.

The aforesaid intensification in agriculture will—unless solutions are found—have a severely negative impact on the environment unless solutions are found to counter nitrogen losses—via nitrous oxide (NO₂) greenhouse gas emissions; and (NO₃) leaching into waterways via nitrification—from nitrogen-based fertilisers and animal urine.

NBPT and DMPP are respectively a urease inhibitor and a nitrification inhibitor both useful in respectively combatting NO₂ emissions (volatilisation) and NO₃ losses mentioned above.

Finding better ways to utilise inhibitor actives-including NBPT and DMPP (or other urease/nitrification inhibitors including N-(n-propyl)thiophosphoric triamide (NPPT) a urease inhibitor, and 2-(3,4-dimethyl-1H-pyrazol-1-yl) succinic acid (DMPSA) a nitrification inhibitor—in farming practice, to address the above concerns remains a priority.

There is a need to prevent environmental N losses and/or increase N use efficiency.

One problem that currently exists is how to efficiently apply nitrification inhibitors and urease inhibitors to land in need thereof.

Ideally, it would be good if there could be provided an aqueous nitrification inhibitor and/or urease inhibitor formulation which could coat a nitrogen or phosphate containing fertiliser granule.

Indeed, a further problem that needs to be addressed is that presently acidic fertilisers such as phosphate fertilisers degrade NBPT upon coming into contact therewith. This makes co-application of urea with other acidic fertilisers to provide requisite nutrients in a single application step not possible.

It would therefore be ideal if either the coating of a urea granule/chip or the coating of a phosphorous fertiliser granule or chip could enable not only:
enable urea and phosphorous to be mixed without adverse reaction, but also
enable NBPT coated urea granules to also be mixed with the phosphate fertiliser granules without degradation of NBPT occurring, due to the low pH of phosphate fertilisers.

It would also be useful if there could be provided an aqueous formulation which can be used for suspending and holding in suspension NBPT rather than organic solvents which are flammable and can react with fertilisers.

Moreover, it would also be useful if the aqueous formulation can be used for also suspending and holding in suspension other urease/nitrification inhibitors including DMPP; NPPT; and DMPSA.

It would also be useful if there could be provided an aqueous formulation which can be used for suspending and holding in suspension urease/nitrification inhibitors which is made from renewable resources which are also non-toxic/biodegradable.

It would also be useful to have ready-made pre-mixes of one or more of the main components of the aqueous formulation which are suitable for storage and transportation prior to addition of the inhibitor actives.

There is a need for an aqueous coating composition which includes NBPT in suspension which can be used for coating fertiliser granules including urea.

Alternatively, there is also a need for an aqueous coating composition which includes DMPP; NPPT; or DMPSA; therein, which can be used for coating fertiliser granules.

Previously, these issues were addressed in the applicant's earlier filed PCT application WO2015034375 which utilises clay and an aqueous wax dispersion to provide a protective coating formulation for an inhibitor active on a urea granule.

It would be useful if there could be provided an alternative aqueous coating formulation which addressed the abovementioned issues but has no requirement for an aqueous wax dispersion (i.e. wax and surfactants) as per the applicant's earlier filed PCT application or always needing clay to be present—in order to be effective.

It would also be useful to have an aqueous coating formulation which can retain flowability (i.e. have suitable viscosity) down to zero degrees Celsius.

Thus whilst, the examples provide below may be thicker than equivalent solvent based products, the examples below still show the aqueous coating formulation of the present invention still ‘flows’ and is stable for spray applications (all that's important) at the stated temperature ranges.

It is an object of the present invention to address the foregoing problems or at least to provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

Throughout this specification, the word “comprise”, or variations thereof such as “comprises” or “comprising”, will be understood to imply the inclusion of a stated element, integer or step, or group of elements integers or steps, but not the exclusion of any other element, integer or step, or group of elements, integers or steps.

Further aspects and advantages of the present invention will become apparent from the ensuing description which is given by way of example only.

### DEFINITIONS AND CLARIFICATIONS

The term ‘thickening agent’ as used herein refers to gums, polysaccharides, proteins, fats and oils, or a combination thereof which can be used to increase the viscosity of water. The term ‘thickening agent’ as used herein does not include clay.

The types of clays that may be used in the present invention include any clays that are suitable to be used as extenders in paints such as would be known to those skilled in the art. A non-limiting list of extenders other than clay includes:
silica and silicates,
diatomaceous silica,
calcium carbonate,
talc and
zinc oxide.

The term ‘inhibitor active(s)’ as used herein refers to nitrification inhibitors or urease inhibitors including NBPT; DMPP; NPPT; or DMPSA.

The terms ‘granule’ and ‘chip’ as used herein are used interchangeably and refer to a small compact particle of substance. The particle will generally be of a size in the order of substantially between 1 mm-10 mm and most preferably between 2 mm-5 mm. The granule/chip may be naturally occurring or may be fashioned by human manipulation.

The term ‘mineral’ as used herein refers to a solid naturally occurring substance which is beneficial to a plant or animal life. Some non-limiting exemplary examples will be detailed subsequently herein.

The term ‘fertiliser’ as used herein refers to any substance added to soil, land or other plant growth medium in order to increase fertility.

The term ‘assimilable’ as used herein refers to a substance which is able to be absorbed by a plant or animal.

The term ‘trace elements’ as used herein refers to a chemical element found in small quantities in plants and/or the earth and which is used by organisms, including plants and animals, and is essential or beneficial, to their physiology. Some non-limiting exemplary examples will be detailed subsequently herein.

### SUMMARY OF THE INVENTION

The present invention generally relates to a new aqueous coating formulation which includes minimal ingredients therein compared to the prior art, and yet, despite this fact, can be used to stably hold powdered trace elements and/or NBPT or other urease inhibitors/nitrification inhibitors:
in suspension for coating onto fertiliser granules; or
on urea granules to provide protection against degradation of NBPT for up to 5 months.

The applicant has found that the present invention remains stable and the NBPT does not degrade for up to 5 months when applied to urea granules or when held in suspension in a coating formulation.

One surprising aspect of the present invention is that the aqueous coating formulation can comprise 69% w/w up to 99% w/w water.

In particular, the amount of NBPT measured at day 130 remained at substantially the same amount (300 ppm) as was measured on day 1 allowing for a margin of error of 5%.

According to a first aspect of the present invention there is provided an aqueous urease inhibitor and/or nitrification inhibitor coating formulation essentially consisting of:
a thickening agent;
NBPT or other urease inhibitors/nitrification inhibitors;
water.

According to a second aspect of the present invention there is provided an aqueous urease inhibitor and/or nitrification inhibitor coating formulation substantially as described above wherein the thickening agent is a guar gum or a xanthate gum.

According to a third aspect of the present invention there is provided an aqueous urease inhibitor and/or nitrification inhibitor coating formulation substantially as described above which further consists of kaolin clay or calcium betonite.

According to a fourth aspect of the present invention there is provided an aqueous urease inhibitor and/or nitrification inhibitor coating formulation substantially as described above which further consists of powdered ZnO.

According to a fifth aspect of the present invention there is provided an aqueous urease inhibitor and/or nitrification inhibitor coating formulation substantially as described above wherein the average particle size of substantially 45 micron or less.

According to a sixth aspect of the present invention there is provided an aqueous urease inhibitor and/or nitrification inhibitor coating formulation substantially as described above wherein:
the thickening agent is present at amount of 0.1% w/w to 1.0% w/w;
wherein NBPT or other urease inhibitors/nitrification inhibitor is present in the amount of 0.5% w/w to 35% w/w;
water to make up to 100% w/w.

According to a seventh aspect of the present invention there is provided a fertiliser composition which includes a nutrient source in the form of a fertiliser granule or chip, the granule or chip coated with an aqueous urease inhibitor and/or nitrification inhibitor coating composition substantially as described above.

According to an eighth aspect of the present invention there is provided a fertiliser composition substantially as described above wherein the fertiliser chip or granule is urea.

According to a ninth aspect of the present invention there is provided a fertiliser blend including a quantity of a fertiliser composition substantially as described above together with a quantity of a fertiliser selected from granular or chip forms of:
Single super phosphate;
Diammonium phosphate
Monoammonium phosphate;
Ammonium polyphosphate;
Ammonia sulphate;
Potassium chloride;
Potassium sulphate;
Potassium carbonate; or
Potassium hydrochloride.

According to a 10^{th} aspect of the present invention there is provided an aqueous urease inhibitor and/or nitrification inhibitor coating formulation substantially as described above wherein the thickening agent is selected from gums including microbial gums, starches or gelatins.

According to an 11^{th} aspect of the present invention there is provided a fertiliser coating formulation consisting essentially of:
a thickening agent is present at an amount of substantially 0.1% to 1.0% w/w;
at least one powdered trace element at an amount of substantially 5% w/w to 60% w/w;
water to make up to 100% w/w.

According to a 12^{th} aspect the present invention there is provided a fertiliser coating formulation substantially as above which further consists of NBPT or other urease inhibitors/nitrification inhibitors.

According to a 13^{th} aspect the present invention there is provided an aqueous urease inhibitor and/or nitrification inhibitor coating formulation substantially as described above which does not require a surfactant or urea therein.

According to a 14^{th} aspect the present invention there is provided an aqueous urease inhibitor and/or nitrification inhibitor coating formulation substantially as described above which maintains a viscosity below 17,000 cP at zero degrees Celsius.

According to a 15^{th} aspect the present invention there is provided an aqueous urease inhibitor and/or nitrification inhibitor coating formulation substantially as described above which maintains a viscosity below 10,000 cP at zero degrees Celsius.

### BEST MODES FOR CARRYING OUT THE INVENTION

### Example 1

150 kg NBPT
4 kg Xanthan Gum
846 kg H2O

### Method:

Prepare liquid phase by mixing the xanthan gum into water. Best results will be achieved by using a high shear mixer, for example a Silverson dispersion mixer.

Now add the NBPT into the mixing vessel. Best results will be done with a high speed dispersion mixer like those used in the paint industry.

The applicant had independent testing performed on a sample made in accordance with Example 1 by ARL Laboratories the results were the sample went from 15.00% NBPT on day 1, to 14.69%, over 180 days (within margin of error of 5%).

### Example 2

150 kg NBPT
100 kg Kaolin Clay
5 kg Guar Gum
746 kg H2O

### Method:

Prepare liquid phase by mixing the guar gum in water. Best results will be achieved by using a high shear mixer, for example a Silverson dispersion mixer.

Pre-blend the NBPT and Clay in a dry phase with a ribbon blender.

Now add the NBPT/clay mix into the liquid mixing vessel. Best results will be done with a high speed dispersion mixer like those used in the paint industry.

### Example 3

200 kg NBPT
100 kg
4 kg Xanthan Gum
696 kg H2O

### Method:

Prepare liquid phase by mixing the xanthan gum in water. Best results will be achieved by using a high shear mixer, for example a Silverson dispersion mixer.

Pre-blend the NBPT and ZnO in a dry phase with a ribbon blender.

Now add the NBPT/ZnO mix into the liquid mixing vessel. Best results will be done with a high speed dispersion mixer like those used in the paint industry.

### Example 4

50 kg NBPT
100 kg DMPP
50 kg Kaolin Clay
4 kg Xanthan Gum
796 kg H2O

### Method:

Prepare liquid phase by mixing the xanthan gum in water. Best results will be achieved by using a high shear mixer, for example a Silverson dispersion mixer.

Pre-blend the NBPT, Clay and DMPP in a dry phase with a ribbon blender.

Now add the NBPT/Clay/DMPP mix into the liquid mixing vessel. Best results will be done with a high speed dispersion mixer like those used in the paint industry.

### Example 5

50 kg NBPT
100 kg DMPP
50 kg Kaolin Clay
4 kg Xanthan Gum
796 kg H2O

### Method:

Prepare liquid phase by mixing the xanthan gum in water. Best results will be achieved by using a high shear mixer, for example a Silverson dispersion mixer.

Pre-blend the NBPT, Clay and DMPP in a dry phase with a ribbon blender.

Now add the NBPT/Clay/DMPP mix into the liquid mixing vessel. Best results will be done with a high speed dispersion mixer like those used in the paint industry.

### Examples 6-8

The following examples are made using the same or similar methodologies to those outlined above for Examples 1-4.

### Example 6

990 kg H2O
5 kg NBPT
5 kg Xanthan Gum

### Example 7

645 kg H2O
350 kg NBPT
5 kg Guar Gum

This formulation of the present invention can be coated onto urea granules that are to be blended with an acidic fertiliser.

### Example 8

695 kg H2O
300 kg DMPP
5 kg Guar Gum

### Example 9

695 kg H2O
300 kg ZnO
5 kg Guar Gum

### Example 10

945 kg H2O
50 kg ZnO
5 kg Xanthan Gum

### Example 11

25 kg Na2MoO
125 kg ZnO
50 kg Kaolin Clay
4 kg Xanthan Gum
796 kg H2O

### Example 12

150 kg NBPT
4 kg Xanthan Gum
846 kg H2O

This coating formulation had its viscosity measured at various temperatures—as shown in Table 12-1—via a Brookfield AMETEK SC4-16 Spindle operating at 10.00 RPM with a shear rate of 34 s-1.

TABLE 12-1

| | | | Viscosity | Shear Stress |
|---|---|---|---|---|
| Temp | Speed (RPM) | Shear rate | cP | dyne/cm2 |
| 0 C. | 10 | 34 s⁻¹ | 6284 | 1230.2 |
| 10 C. | 10 | 34 s⁻¹ | 2153 | 558.6 |
| 20 C. | 10 | 34 s⁻¹ | 1412 | 391.1 |
| 30 C. | 10 | 34 s⁻¹ | 646 | 145.6 |

Note, generally a viscosity below 20,000 cP will flow under gravity and anything below 10,000 cP will ‘flow well’ under just gravity. For example, molasses has a viscosity of around 5,000-10,000 cP at 21 degrees and ketchup has a viscosity of around 50,000-70,000 cP at 20 degrees.

### Example 13

150 kg NBPT
1 kg Xanthan Gum
849 kg H2O

This coating formulation had its viscosity measured at various temperatures—as shown in Table 13-1—via a Brookfield AMETEK SC4-16 Spindle operating at 10.00 RPM with a shear rate of 34 s-1.

TABLE 13-1

| | | | Viscosity | Shear Stress |
|---|---|---|---|---|
| Temp | Speed (RPM) | Shear rate | cP | dyne/cm2 |
| 0 C. | 10 | 34 s⁻¹ | 6284 | 1230.2 |
| 10 C. | 10 | 34 s⁻¹ | 2153 | 558.6 |
| 20 C. | 10 | 34 s⁻¹ | 1412 | 391.1 |
| 30 C. | 10 | 34 s⁻¹ | 646 | 145.6 |

To understand relative viscosities refer the note in Example 12 above.

### Example 14

150 kg NBPT
100 kg Kaolin Clay
5 kg Guar Gum
745 kg H2O

This coating formulation had its viscosity measured at various temperatures—as shown in Table 14-1—via a Brookfield AMETEK SC4-16 Spindle operating at 10.00 RPM with a shear rate of 34 s-1.

TABLE 14-1

| | | | Viscosity | Shear Stress |
|---|---|---|---|---|
| Temp | Speed (RPM) | Shear rate | cP | dyne/cm2 |
| 0 C. | 10 | 34 s⁻¹ | 7459 | 1279.4 |
| 10 C. | 10 | 34 s⁻¹ | 2437 | 564.2 |
| 20 C. | 10 | 34 s⁻¹ | 1637 | 398.6 |
| 30 C. | 10 | 34 s⁻¹ | 811 | 146.7 |

To understand relative viscosities refer the note in Example 12 above.

### Example 15

200 kg NBPT
100 kg ZnO
4 kg Xanthan Gum
696 kg H2O

This coating formulation had its viscosity measured at various temperatures—as shown in Table 15-1—via a Brookfield AMETEK SC4-16 Spindle operating at 10.00 RPM with a shear rate of 34 s-1.

TABLE 15-1

| | | | Viscosity | Shear Stress |
|---|---|---|---|---|
| Temp | Speed (RPM) | Shear rate | cP | dyne/cm2 |
| 0 C. | 10 | 34 s⁻¹ | 8226 | 1328.7 |
| 10 C. | 10 | 34 s⁻¹ | 2682 | 575.3 |
| 20 C. | 10 | 34 s⁻¹ | 1793 | 424.9 |
| 30 C. | 10 | 34 s⁻¹ | 878 | 168.2 |

To understand relative viscosities refer the note in Example 12 above.

### Example 16

50 kg NBPT
150 kg Kaolin Clay
10 kg Xanthan Gum
790 kg H2O

This coating formulation had its viscosity measured at various temperatures—as shown in Table 16-1—via a Brookfield AMETEK SC4-16 Spindle operating at 10.00 RPM with a shear rate of 34 s-1.

TABLE 16-1

| | | | Viscosity | Shear Stress |
|---|---|---|---|---|
| Temp | Speed (RPM) | Shear rate | cP | dyne/cm2 |
| 0 C. | 10 | 34 s⁻¹ | 9284 | 930.2 |
| 10 C. | 10 | 34 s⁻¹ | 3192 | 456.4 |
| 20 C. | 10 | 34 s⁻¹ | 2628 | 345.8 |
| 30 C. | 10 | 34 s⁻¹ | 1240 | 128.1 |

To understand relative viscosities refer the note in Example 12 above.

### Example 17

150 kg DMPP
150 kg Kaolin Clay
4 kg Xanthan Gum
696 kg H2O

This coating formulation had its viscosity measured at various temperatures—as shown in Table 17-1—via a Brookfield AMETEK SC4-16 Spindle operating at 10.00 RPM with a shear rate of 34 s-1.

TABLE 17-1

| | | | Viscosity | Shear Stress |
|---|---|---|---|---|
| Temp | Speed (RPM) | Shear rate | cP | dyne/cm2 |
| 0 C. | 10 | 34 s⁻¹ | 7546 | 1289.2 |
| 10 C. | 10 | 34 s⁻¹ | 2541 | 572.8 |
| 20 C. | 10 | 34 s⁻¹ | 1697 | 404.7 |
| 30 C. | 10 | 34 s⁻¹ | 824 | 151.0 |

To understand relative viscosities refer the note in Example 12 above.

### Example 18

797 kg H2O
200 kg NBPT
3 kg Guar Gum

This coating formulation had its viscosity measured at various temperatures—as shown in Table 18-1—via a Brookfield AMETEK SC4-16 Spindle operating at 10.00 RPM with a shear rate of 34 s-1.

TABLE 18-1

| | | | Viscosity | Shear Stress |
|---|---|---|---|---|
| Temp | Speed (RPM) | Shear rate | cP | dyne/cm2 |
| 0 C. | 10 | 34 s⁻¹ | 8226 | 738.2 |
| 10 C. | 10 | 34 s⁻¹ | 2682 | 422.1 |
| 20 C. | 10 | 34 s⁻¹ | 1793 | 346.7 |
| 30 C. | 10 | 34 s⁻¹ | 878 | 129.4 |

To understand relative viscosities refer the note in Example 12 above.

### Example 19

795 kg H2O
200 kg DMPP
5 kg Guar Gum

This coating formulation had its viscosity measured at various temperatures—as shown in Table 19-1—via a Brookfield AMETEK SC4-16 Spindle operating at 10.00 RPM with a shear rate of 34 s-1.

TABLE 19-1

| | | | Viscosity | Shear Stress |
|---|---|---|---|---|
| Temp | Speed (RPM) | Shear rate | cP | dyne/cm2 |
| 0 C. | 10 | 34 s⁻¹ | 9289 | 901.6 |
| 10 C. | 10 | 34 s⁻¹ | 3012 | 588.4 |
| 20 C. | 10 | 34 s⁻¹ | 2103 | 678.6 |
| 30 C. | 10 | 34 s⁻¹ | 1001 | 148.8 |

To understand relative viscosities refer the note in Example 12 above.

### Example 20

396 kg H2O
600 kg Zinc
4 kg Xanthan Gum

This coating formulation had its viscosity measured at various temperatures—as shown in Table 20-1—via a Brookfield AMETEK SC4-16 Spindle operating at 10.00 RPM with a shear rate of 34 s-1.

TABLE 20-1

| | | | Viscosity | Shear Stress |
|---|---|---|---|---|
| Temp | Speed (RPM) | Shear rate | cP | dyne/cm2 |
| 0 C. | 100 | 34 s⁻¹ | 7015 | 1685.1 |
| 10 C. | 100 | 34 s⁻¹ | 2015 | 685.1 |
| 20 C. | 100 | 34 s⁻¹ | 1553 | 527.9 |
| 30 C. | 100 | 34 s⁻¹ | 1190 | 404.6 |

To understand relative viscosities refer the note in Example 12 above.

### Example 21

697 g H2O
300 kg NBPT
4 kg Xanthan Gum

This coating formulation had its viscosity measured at various temperatures—as shown in Table 21-1—via a Brookfield AMETEK SC4-16 Spindle operating at 10.00 RPM with a shear rate of 34 s-1.

TABLE 21-1

| | | | Viscosity | Shear Stress |
|---|---|---|---|---|
| Temp | Speed (RPM) | Shear rate | cP | dyne/cm2 |
| 0 C. | 10 | 34 s⁻¹ | 15341 | 1948.3 |
| 10 C. | 10 | 34 s⁻¹ | 6836 | 1556.9 |
| 20 C. | 10 | 34 s⁻¹ | 3401 | 1444.0 |
| 30 C. | 10 | 34 s⁻¹ | 2474 | 1186.8 |

To understand relative viscosities refer the note in Example 12 above.

### Example 22

697 kg H2O
300 kg DMPP
4 kg Xanthan Gum

This coating formulation had its viscosity measured at various temperatures—as shown in Table 22-1—via a Brookfield AMETEK SC4-16 Spindle operating at 10.00 RPM with a shear rate of 34 s-1.

TABLE 22-1

| | | | Viscosity | Shear Stress |
|---|---|---|---|---|
| Temp | Speed (RPM) | Shear rate | cP | dyne/cm2 |
| 0 C. | 10 | 34 s⁻¹ | 16497 | 2065.1 |
| 10 C. | 10 | 34 s⁻¹ | 7233 | 1603.6 |
| 20 C. | 10 | 34 s⁻¹ | 3522 | 1487.3 |
| 30 C. | 10 | 34 s⁻¹ | 2598 | 1222.4 |

To understand relative viscosities refer the note in Example 12 above.

### Further Discussion of the Invention Including Non-Limiting Alternate Ways to Implement the Invention

The thickening agent may preferably be a gum such as xanthate or guar.

The dispersing clay may be any clay which has a particle size of less than 20 microns and is inert.

In one embodiment the dispersing clay may be kaolin clay.

In one embodiment 90% of the kaolin clay particles may be under substantially 10 microns in size.

In another embodiment the dispersing clay be calcium bentonite may have a particle size of under substantially 20 microns.

The clay and thickening agent play an important role in the formulation as the inventors have surprisingly found they enable NBPT and other inhibitor actives to be stably held in suspension in water in a freely flowable form.

Without wanting to be bound by theory-typically the gum rate increases as the NBPT or ZnO powder loading increases as the mixture in the liquid formulation gets heavier and needs more help being suspended. Also note NBPT is relatively light so the generally increased gum may only be required when heavy powders like clay or oxides are included at high rates.

The present invention is unique as it does not require the use of any other ingredients to suspend or otherwise assist or support the coating formulation such as buffers, polymers, or surfactants.

In some preferred embodiments the fertiliser granule or chip to be coated with the coating formulation of the present invention may be selected from one or more of the following assimilable forms:
Single super phosphate;
Diammonium phosphate;
Monoammonium phosphate;
Ammonium Polyphosphate;
Ammonium sulphate;
Potassium chloride;
Potassium Sulphate;
Potash e.g. potassium carbonate or potassium hydrochloride.
Granular DAP;
Granular MAP;
Granular Super Phosphate/Triple Super Phosphate;
Granular MOP;
Magnesium Oxide Chip average particle size of 45 micron or above; and
Lime Chip.
   This list is not intended to be exhaustive.

Some non-limiting exemplary examples, of suitable powdered trace elements for the coating include plant and/or animal assimilable forms of:
Magnesium
Molybdenum
Silicon
Copper
Boron
Selenium
Zinc
Iron
Manganese
Iodine
Calcium

However, this list is not intended to be exhaustive.

The minerals may be any minerals it is desired to deliver to a plant.

In some embodiments whilst the minerals may primarily benefit the plant (e.g. for increased growth or other desired physiological response) the minerals may also be beneficial to an animal upon delivery thereto via the animal's ingestion of a plant.

Preferably, the powdered trace elements have an average particle size of substantially 45 micron or less.

The invention may also be said broadly to consist in the parts, elements and features referred to or indicated in the specification of the application, individually or collectively, in any or all combinations of two or more of said parts, elements or features.

Aspects of the present invention have been described by way of example only and it should be appreciated that modifications and additions may be made thereto without departing from the scope thereof as defined in the appended claims.

1. An aqueous urease inhibitor and/or nitrification inhibitor coating formulation essentially consisting of:
a thickening agent;
NBPT or other urease inhibitors/nitrification inhibitors; and
water;
wherein said coating formulation is applied to urea granules, or other non-acidic fertilizer granules; wherein:
the thickening agent is present at amount of 0.1% w/w to 1.0% w/w;
wherein the NBPT or the other urease inhibitors/nitrification inhibitor is present in the amount of 0.5% w/w to 35% w/w; and
water to make up to 100% w/w.

2. An aqueous urease inhibitor and/or nitrification inhibitor coating formulation as claimed in 1 wherein the thickening agent is a guar gum or a xanthate gum.

3. An aqueous urease inhibitor and/or nitrification inhibitor coating formulation as claimed in 1 which further consists of kaolin clay or calcium betonite.

4. An aqueous urease inhibitor and/or nitrification inhibitor coating formulation as claimed in claim 1 which further consists of powdered ZnO.

5. An aqueous urease inhibitor and/or nitrification inhibitor coating formulation as claimed in claim 3 wherein the average particle size of ZnO, kaolin clay or calcium betonite is substantially 45 micron or less.

6. An aqueous urease inhibitor and/or nitrification inhibitor coating formulation as claimed in claim 1 wherein:
the thickening agent is present at amount of 0.1% w/w to 1.0% w/w;
wherein the NBPT or the other urease inhibitors/nitrification inhibitor is present in the amount of 0.5% w/w to 35% w/w;
water to make up to 100% w/w.

7. A fertilizer composition which includes a nutrient source in the form of a fertilizer granule or chip, the granule or chip coated with an aqueous urease inhibitor and/or nitrification inhibitor coating composition as claimed in claim 1.

8. A fertilizer composition as claimed in claim 7 wherein the fertilizer chip or granule is urea.

9. A fertilizer blend including a quantity of a fertilizer composition as claimed in claim 8 together with a quantity of a fertilizer selected from granular or chip forms of:
Single super phosphate;
Diammonium phosphate
Monoammonium phosphate;
Ammonium polyphosphate;
Ammonia sulphate;
Potassium chloride;
Potassium sulphate;
Potassium carbonate; or
Potassium hydrochloride.

10. An aqueous urease inhibitor and/or nitrification inhibitor coating formulation as claimed in claim 1 wherein the thickening agent is selected from gums including microbial gums, starches or gelatins.

11. An aqueous urease inhibitor and/or nitrification inhibitor coating formulation as claimed in claim 1 which does not require a surfactant or urea therein.

12. An aqueous urease inhibitor and/or nitrification inhibitor coating formulation as claimed in claim 1 which maintains a viscosity below 17,000 cP at zero degrees Celsius.

13. An aqueous urease inhibitor and/or nitrification inhibitor coating formulation as claimed in claim 1 which maintains a viscosity below 10,000 cP at zero degrees Celsius.
